(19) United States
(12) Patent Application Publication
(10) Pub. No.: US 2022/0099488 A1
(43) Pub. Date: Mar. 31, 2022

(54) MULTI-CHANNEL ARRAY TYPE OPTICAL SENSING DEVICE AND MANUFACTURING METHOD THEREOF

(71) Applicant: Taiwan RedEye Biomedical Inc., Hsinchu City (TW)

(72) Inventors: Shuo-Ting Yan, Hsinchu City (TW); I-Hua Wang, Hsinchu City (TW); Chen-Chung Chang, Hsinchu City (TW); Tsung-Jui Lin, Hsinchu City (TW)

(21) Appl. No.: 17/037,675

(22) Filed: Sep. 30, 2020

(51) Int. Cl. G01J 3/02

(52) U.S. Cl. CPC G01J 3/0294; G01J 2003/2806; G01J 3/0291

(57) ABSTRACT

Disclosed are a multi-channel array type optical sensing device and its manufacturing method, and the device includes an encapsulating housing and at least one electrical contact on a side of the encapsulating housing. The encapsulating housing includes a printed circuit board, a light receiving unit, and a filter array for receiving an external incident light and converting the external incident light into a multi-channel optical signal with a non-continuous wavelength. The light receiving unit is electrically connected to the printed circuit board for receiving the multi-channel optical signal. The printed circuit board is provided for transmitting the multi-channel optical signal to the outside through the at least one electrical contact. With a simple design, the multi-channel array type optical sensing device becomes an optical component with the features of low cost and easily extended application and suitable for the spectral analysis of various testing objects.

### FIELD OF INVENTION

The present invention relates to the field of optical sensing instruments, in particular to a multi-channel array type optical sensing device and its manufacturing method with the features of low cost and easily extended application.

### BACKGROUND OF INVENTION

### Description of the Related Art

Since each element has its own unique spectrum, substances can be identified and their chemical composition can be determined based on their spectrum, and this is called spectral analysis. In recent years, electronics, medicine, optoelectronics and other fields are booming, and the demand for the use of spectrometers to analyze photophysical and photochemical phenomena of materials is increasing.

Spectrometer is a scientific instrument with a main function of decomposing complex light into spectral lines and capable of measuring the light reflected from a surface of an object, the penetrating light penetrating the object, and the light absorbed by the object. Although the conventional spectrometer has the function of optical analysis, the spectrometer is mainly composed of components including prisms and diffraction gratings, so that the cost is high, the volume is large, and the application is impractical.

To lower the cost of optical analysis, there are micro-spectrometers on the market, and a microelectromechanical system (MEMS) process for semiconductors is used to miniaturize the optical structure. Although both cost and volume can be reduced, the micro-spectrometers applied to home testing still have cost barriers to market entry.

Regardless of the conventional spectrometer or the (MEMS) spectrometer for semiconductors, these spectrometers have a continuous full spectrum (UV-VIS) specification, and thus the manufacturing cost is relatively high and uneasy to be introduced into home applications.

In the market, another non-continuous sensor is developed and produced by manufacturing a photodiode array on a silicon wafer to work with a filter array. Although the production cost of the non-continuous sensors can be reduced by mass production, the manufacturing cost of the silicon wafers is very high and fails to reduce the manufacturing cost effectively if a specific production yield has not been reached. Therefore, it is an important subject for related optical sensor manufacturers to satisfy the requirements of improving the photosensitivity, decreasing the quantity of optical components, and lowering the development and production costs, and expanding the application of the optical analysis to general home-based testing.

### SUMMARY OF THE INVENTION

In view of the drawbacks of the prior art, it is a primary objective of the present invention to provide a multi-channel array type optical sensing device and its manufacturing method with the features of low cost and easily extended application for optical inspections.

To achieve the aforementioned and other objectives, the present invention discloses a multi-channel array type optical sensing device, comprises: an encapsulating housing, having at least one electrical contact installed on a side of the encapsulating housing; a filter array, installed in the encapsulating housing, for receiving an external incident light, and converting the external incident light into a multi-channel optical signal with a non-continuous wavelength; a light receiving unit, encapsulated into the encapsulating housing, and disposed under the filter array, for receiving the multi-channel optical signal; and a printed circuit board, encapsulated into the encapsulating housing and electrically coupled between the light receiving unit and the at least one electrical contact, for transmitting the multi-channel optical signal to the outside through the at least one electrical contact.

In the multi-channel array type optical sensing device, the filter array is an array type glass filter unit having a plurality of filters with different wavelengths installed the filter array.

In the multi-channel array type optical sensing device, the filter array is comprised of a plurality of filters of different wavelengths.

In the multi-channel array type optical sensing device, the light receiving unit is a photodiode array.

The multi-channel array type optical sensing device further comprises a reflective light shielding layer installed between the filter array and the light receiving unit, for limiting a stray light distribution of the multi-channel optical signal.

The multi-channel array type optical sensing device further comprises a transparent protective layer disposed above the filter array.

The present invention further provides a manufacturing method of a multi-channel array type optical sensing device, and the method comprises the steps of: providing an encapsulating housing, and installing at least one electrical contact on a side of the encapsulating housing; installing a filter array in the encapsulating housing, and using the filter array to receive an external incident light and convert the external incident light into a multi-channel optical signal with a non-continuous wavelength; installing a light receiving unit under the filter array to receive the multi-channel optical signal; and electrically coupling a printed circuit board between the light receiving unit and the at least one electrical contact to transmit the multi-channel optical signal to the outside through the at least one electrical contact.

In the manufacturing method of a multi-channel array type optical sensing device, wherein the filter array is an array type glass filter unit having a plurality of filters of different wavelengths installed on the filter array.

In the manufacturing method of a multi-channel array type optical sensing device, wherein the filter array is comprised of a plurality of filters of different wavelengths.

In the manufacturing method of a multi-channel array type optical sensing device, wherein the light receiving unit is a photodiode array.

The manufacturing method of a multi-channel array type optical sensing device further comprises the step of: providing reflective light shielding layer installed between the filter array and the light receiving unit to limit a stray light distribution of the multi-channel optical signal.

The manufacturing method of a multi-channel array type optical sensing device further comprises the step of providing a transparent protective layer disposed above the filter array.

### BRIEF DESCRIPTION OF THE DRAWINGS

FIG. 1 is a cross-sectional side view of a color changing television antenna with LED in accordance with an embodiment the present invention

FIG. 2 is a top view of a filter array of the first embodiment of the present invention;

FIG. 3 shows a spectrum of blood absorption;

FIG. 4 is a cross-sectional side view of a multi-channel array type optical sensing device in accordance with a second embodiment of the present invention;

FIG. 5 is a cross-sectional side view of a multi-channel array type optical sensing device in accordance with a third embodiment of the present invention; and

FIG. 6 is a cross-sectional side view of a multi-channel array type optical sensing device in accordance with a fourth embodiment of the present invention.

### DESCRIPTION OF THE PREFERRED EMBODIMENTS

To make it easier for our examiner to understand the objective of the invention, its structure, innovative features, and performance, we use a preferred embodiment together with the attached drawings for the detailed description of the invention.

The directional terms and their similar terms used in the specification of the present invention such as “front”, “rear”, “left”, “right” “up (top)”, down (bottom)”, “inside”, “outside”, “side”, etc. are primarily used by referring the directions of the attached drawings, and the directional terms, or their similar terms just only used for assisting the description and illustration of each embodiment of the present invention, but not intended for limiting the scope of the present invention.

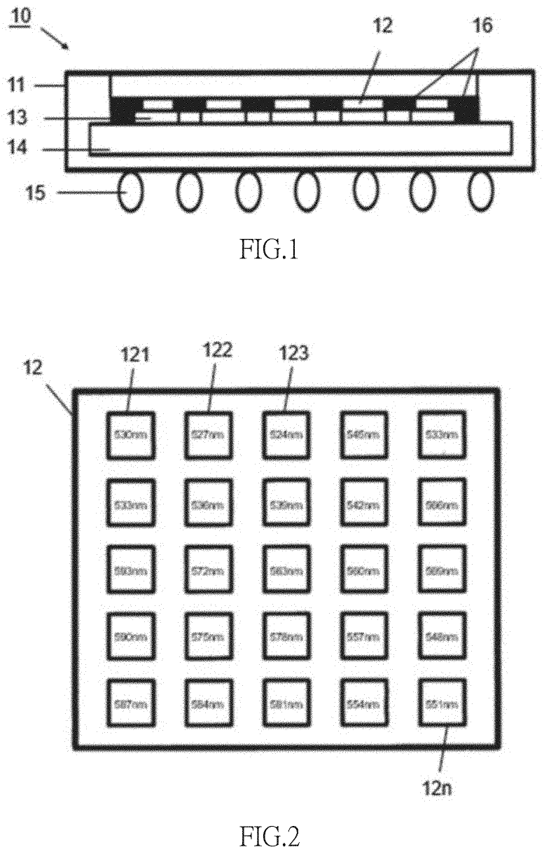

With reference to FIG. 1 for a cross-sectional side view of a multi-channel array type optical sensing device in accordance with the first embodiment of the present invention, the multi-channel array type optical sensing device 10 comprises an encapsulating housing 11, and at least one electrical contact (or soldering contact point) 15 disposed on a side (a side surface or the bottom) of the encapsulating housing 11 and provided for combining with an external electronic device (not shown in the figure). As the name suggests, the encapsulating housing 11 such as a hard shell or other enclosures with a protective function can protect and prevent the electronic components in the encapsulating housing 11 from being contaminated with dust or dirt. The encapsulating housing 11 also can protect the electronic components therein from being hit and damaged by external forces.

The encapsulating housing 11 comprises a printed circuit board 14, a light receiving unit 13 and a filter array 12. The filter array 12 is an array type glass filter unit for receiving external incident light. With reference to FIG. 2 for a top view of a filter array in accordance with an embodiment of the present invention, the filter array 12 is installed with a plurality of filters of different wavelengths 121˜12n. The purpose of installing the filters 121˜12n is to allow the light of specific wavelengths to pass through and block and block the light having wavelengths other than the specific ones. Therefore, when the external incident light is projected onto the filters 121˜12n, only the light with the specific wavelengths can pass through the filters 121˜12n, and it is similar to the conversion of the light into a multi-channel optical signal with a non-continuous wavelength. The structure of a plurality of filters of different wavelengths can be designed according the required wavelength. In other words, a light division effect of a plurality of wavelengths is produced, and these divided lights (which are the non-continuous spectra) can be used to achieve a non-continuous spectral analysis.

The light receiving unit 13 is a photodiode array electrically coupled to the printed circuit board 14. In other embodiments, the light receiving unit ‘3 can be fixed onto the printed circuit board 14 for receiving a multi-channel optical signal with a non-continuous wavelength. The multi-channel optical signal is transmitted by the light receiving unit 13 to the printed circuit board 14, and the printed circuit board 14 transmits the multi-channel optical signal to the outside through the at least one electrical contact 15.

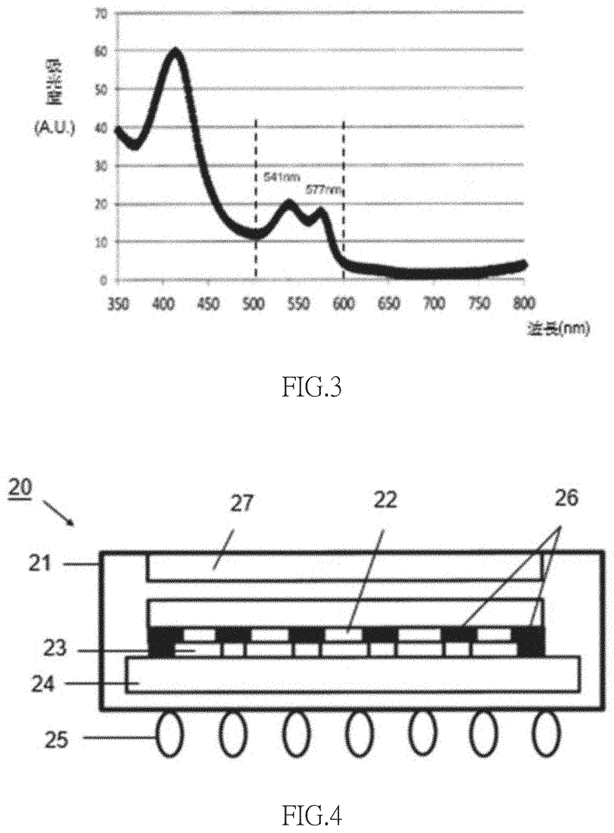

With reference to FIG. 3 for the spectrum of blood absorption, human blood has an absorption characteristic similar to a M-shaped pattern in the absorption spectrum within a range of 500˜600 nm, particularly 541˜577 nm, in addition to an obvious absorption peak value of approximately 415 nm in the human blood absorption spectrum, so that users can use such characteristic to identify whether or not there is any blood signal in a testing aqueous solution by projecting a light beam onto the testing aqueous solution and then using the multi-channel array type optical sensing device 10 of the present invention to receive and divide the light passing through the testing aqueous solution. If there is an absorption characteristic similar to the M-shaped pattern shown in the spectrum, then it will show the presence of blood, or else there is no blood. This detection method can be adjusted according to the biological characteristics of the testing target. For example, if the target is blood to be tested, then filters with different wavelengths can be designed between 500˜600 nm to divide light into 25 wavelengths, and signals of these wavelengths can be used in an algorithm to analyze and determine whether or not there is blood composition. If the target is protein to be tested, the selected wavelength range will not be 500˜600 nm, but will be changed to 250˜350 nm, because the spectral characteristic of protein is mainly shown at the wavelength of 280 nm.

The multi-channel array type optical sensing device 10 of the present invention further comprises a reflective light shielding layer 16 installed between the filter array 12 and the light receiving unit 13 for limiting a stray light distribution of the multi-channel optical signal to avoid the output of stray light from affecting the testing result.

With reference to FIG. 4 for the cross-sectional side view of a multi-channel array type optical sensing device in accordance with the second embodiment of the present invention, the multi-channel array type optical sensing device 20 comprises an encapsulating housing 21, and at least one electrical contact (or a soldering contact point) 25 disposed on a side (a side surface or the bottom) of the encapsulating housing 21 for combining to an external electronic device (not shown in the figure). The encapsulating housing 21 comprises a printed circuit board 24, a light receiving unit 23, a filter array 22 and a transparent protective layer 27. Compared with the first embodiment, the second embodiment adds a transparent protective layer 27 but omits the reflective light shielding layer. The transparent protective layer 27 is disposed above the filter array 22 and cut evenly at the top surface of the encapsulating housing 21. Therefore, after the external incident light is passed through the transparent protective layer 27 and received by the filter array 22, the division of light is performed, and the filter array 22 is not in direct contact with the outside, so as to improve its service life.

With reference to FIG. 5 for the cross-sectional side view of a multi-channel array type optical sensing device in accordance with the third embodiment of the present invention, the filter array 22 is comprised of a plurality of independent filters 221˜22n with different wavelengths. Compared with the filter array 12 (which is an array type glass filter unit) of the first embodiment, this embodiment provides a flexible use. Since the filter array 22 is formed by a plurality of independent filters 221˜22n with different wavelengths, it is necessary to have a reflective light shielding layer 26 at the surrounding of the filters 221˜22n for limiting a stray light distribution of the multi-channel optical signal to avoid the stray light from affecting the testing result.

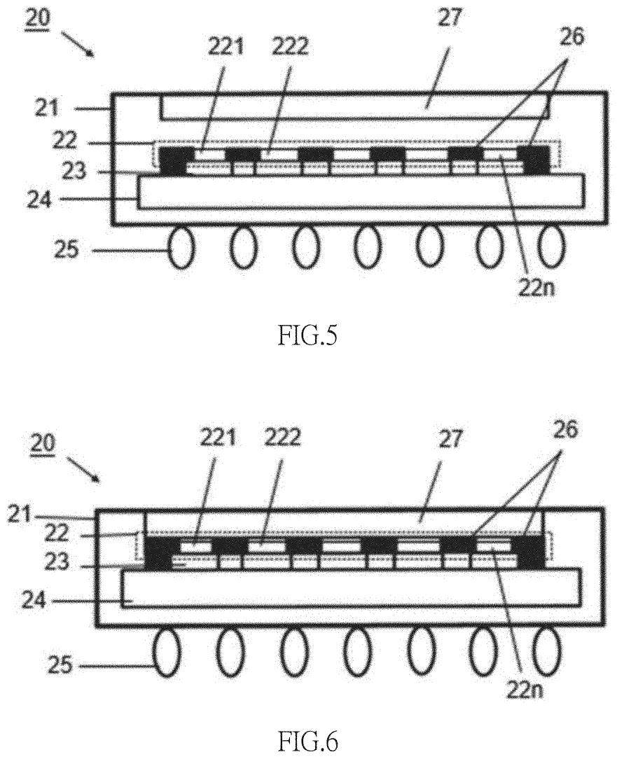

With reference to FIG. 6 for the cross-sectional side view of a multi-channel array type optical sensing device in accordance with the fourth embodiment of the present invention, the difference between this embodiment and the aforementioned embodiments resides on that the transparent protective layer 27 and the filter array 22 of this embodiment are stacked together as a whole, and a transparent adhesive is used for adhesion to prevent the light from being refracted.

By using the filter array formed by the filters of different wavelengths for the division of light, and the non-continuous light division method for the biological test, the manufacturing cost of the multi-channel array type optical sensing device of the present invention can be reduced significantly, and the light characteristics of the testing object can be used for the configuration of the wavelength of the filters of the filter array. In addition, the stacked structure of the optical components of the multi-channel array type optical sensing device of the present invention is not complicated, so as to achieve the effects of miniaturizing the optical structure, simplifying the assembling process, reducing the consumption of materials, lowering the level of difficulty, and also providing easily extended applications for various spectral analyses (such as the sweetness of fruits, pesticide detection of vegetables, analysis of biomedical samples and application and development of photoelectric technology, etc.), which assists general home/life testing and overcomes the drawbacks of the prior art.

While the invention has been described by means of specific embodiments, numerous modifications and variations could be made thereto by those skilled in the art without departing from the scope and spirit of the invention set forth in the claims.

1. A multi-channel array type optical sensing device, comprising:
an encapsulating housing, having at least one electrical contact disposed on a side of thereof the encapsulating housing;
a filter array having a plurality of filters of different wavelengths, installed in the encapsulating housing, receiving an external incident light, and converting the external incident light into a multi-channel optical signal with a non-continuous wavelength;
a light receiving unit, encapsulated into the encapsulating housing, disposed under the filter array, and receiving the multi-channel optical signal;
a reflective light shielding layer disposed between adjacent filters of the plurality of filters of the filter array to limit a stray light distribution of the multi-channel optical signal; and
a printed circuit board, encapsulated into the encapsulating housing, electrically coupled between the light receiving unit and the at least one electrical contact, and transmitting the multi-channel optical signal to the outside out through the at least one electrical contact.

2. The multi-channel array type optical sensing device as claimed in claim 1, wherein the filter array is an array type glass filter unit having the plurality of filters installed thereon.

3. The multi-channel array type optical sensing device as claimed in claim 1, wherein the filter array is formed by the plurality of filters.

4. The multi-channel array type optical sensing device as claimed in claim 1, wherein the light receiving unit is a photodiode array.

5. (canceled)

6. The multi-channel array type optical sensing device as claimed in claim 1, further comprising a transparent protective layer disposed above the filter array.

7. A manufacturing method of a multi-channel array type optical sensing device, comprising the steps of:
providing an encapsulating housing, and installing at least one electrical contact on a side of the encapsulating housing;
installing a filter array in the encapsulating housing, and using the filter array to receive an external incident light and convert the external incident light into a multi-channel optical signal with a non-continuous wavelength, wherein the filter array has a plurality of filters of different wavelengths;
installing a light receiving unit under the filter array to receive the multi-channel optical signal;
providing a reflective light shielding layer between adjacent filters of the plurality of filters of the filter array to limit a stray light distribution of the multi-channel optical signal; and
electrically coupling a printed circuit board between the light receiving unit and the at least one electrical contact to transmit the multi-channel optical signal to the outside through the at least one electrical contact.

8. The manufacturing method of a multi-channel array type optical sensing device as claimed in claim 7, wherein the filter array is an array type glass filter unit having the plurality of filters installed thereon.

9. The manufacturing method of a multi-channel array type optical sensing device as claimed in claim 7, wherein the filter array is comprised of the plurality of filters.

10. The manufacturing method of a multi-channel array type optical sensing device as claimed in claim 7, wherein the light receiving unit is a photodiode array.

11. (canceled)

12. The manufacturing method of a multi-channel array type optical sensing device as claimed in claim 7, further comprising the step of providing a transparent protective layer disposed above the filter array.
